(19) United States
(12) Patent Application Publication
(10) Pub. No.: US 2010/0282029 A1
(43) Pub. Date: Nov. 11, 2010

(54) HAND TOOL WITH AUTOMATIC ENGAGING FUNCTION

(76) Inventor: Chih-Ching Hsieh, Fongyuan City (TW)

Correspondence Address: Wang Law Firm, Inc., 4989 Peachtree Parkway,, Suite 200, Norcross, GA, 30092, US

(21) Appl. No.: 12/463,493

(22) Filed: May 11, 2009

(51) Int. Cl. B25B 13/06

(52) U.S. Cl. 81/121.1

(57) ABSTRACT

A hand tool with the function of automatic engaging is disclosed. It has a holding part with a driving head at an appropriate position thereon. The driving head has sleeve parts stacked in layers. The driving head has a sleeve hole for a working object to be automatically embedded therein and engaged with a corresponding sleeve part. The invention enables the user to determine the actual size of the working object for future maintenance.

### BACKGROUND OF THE INVENTION

1. Field of Invention

The invention relates to a hand tool and, in particular, to a hand tool that has at least two sleeve parts on one driving head that can be applied to working objects.

2. Related Art

Consider that a worker uses a hand tool to do some work. Here the hand tool is a fixed wrench (box end wrench or open wrench) or a socket wrench (fixed or ratchet) as an example. When selecting a hand tool of appropriate specification, the worker usually does not measure the size and shape of the object (e.g., a nut) using a measuring tool. Instead, the worker often visually measures the size of the object to determine which hand tool to use. However, such a method sometimes cannot give the correct size because many sizes are close to one another. Therefore, one usually wastes a lot of time in selecting hand tools of the right sizes.

Please refer to FIG. 10 for a conventional hand tool. It has a body 90 with a driving head 91 on one of its ends. The body 90 is provided with sleeves 92 of different sizes. To drive an object (not shown), the user can select a sleeve 92 of the right size and connect it to the driving head 91 for driving the object. However, although the conventional hand tool has the convenience of having various sizes of sleeves 92, there is still the above-mentioned problem of difficulty in confirming the size. As there are more sleeves 92, the size of the body 90 has to be enlarged as well in order to accommodate those sleeves 92. As a result, the wrench is too large in volume and not suitable for working in a narrow space.

Besides, there is a conventional wrench structure as shown in FIG. 11. There are several sleeves 92A of different sizes and retractable in a wrench driving head 91A. Since the sizes of the sleeves 92A are different, the tool can be used on objects of different sizes. However, each of the sleeves 92A in this wrench corresponds to objects of one particular size. If the outer diameter of the object is eroded due to long time use, it is possible that the sleeve 92A may not fit the object. Moreover, this wrench structure cannot show the specification of the sleeve part once it is engaged with a working object. Therefore, in addition to individual trials and errors that are tedious and time-consuming, the user cannot immediately know the actual outer diameter of the working object for future replacements.

Therefore, it is an objective of the invention to provide a hand tool that can automatically the size of a working object.

### SUMMARY OF THE INVENTION

In view of the foregoing, the invention provides a hand tool with an automatic engaging function that helps shortening the time for the user to select the appropriate tool size.

Another objective of the invention is to let a working object automatically urge against the sleeve part of the right size when the user engages the tool with it. Therefore, the driving head can be engaged with working objects with a wider range of size. Even if there is a difference between the visually measured specification and the actual specification or the outer diameter of the working object is damaged, the hand tool can still directly engage it and work.

Another feature of the invention is that its holding part has a displaying part to show the size of the sleeve part once it engage with the working object. The user can thus know the outer diameter of the working object for future references. This increases the user's working efficiency.

To achieve the above-mentioned objectives, the invention includes a holding part that has at least one driving head at an appropriate position. The driving head has at least two sleeve parts disposed coaxially but with different inner diameters. The sleeve parts are stacked inside the driving head to form a sleeve hole for engaging an object. The working object automatically embeds in the sleeve hole and matches with the sleeve part of the corresponding size.

### BRIEF DESCRIPTION OF THE DRAWINGS

The invention will become more fully understood from the detailed description given herein below illustration only, and thus is not limitative of the present invention, and wherein:

FIG. 1 is a three-dimensional view of the invention;

FIG. 2 is a local cross-sectional view of the structure of the disclosed driving head;

FIG. 3 is a schematic view of the larger sleeve part in the invention;

FIG. 4 is a schematic view of the smaller sleeve part in the invention;

FIG. 5 shows the structure in a second embodiment of the invention;

FIG. 6 shows the structure in a third embodiment of the invention;

FIG. 7 shows the structure in a fourth embodiment of the invention;

FIG. 8 shows the structure in a fifth embodiment of the invention;

FIG. 9 shows the structure in a sixth embodiment of the invention;

FIG. 10 is a schematic view of a conventional hand tool; and

FIG. 11 is a schematic view of another conventional hand tool.

### DETAILED DESCRIPTION OF THE INVENTION

The present invention will be apparent from the following detailed description, which proceeds with reference to the accompanying drawings, wherein the same references relate to the same elements.

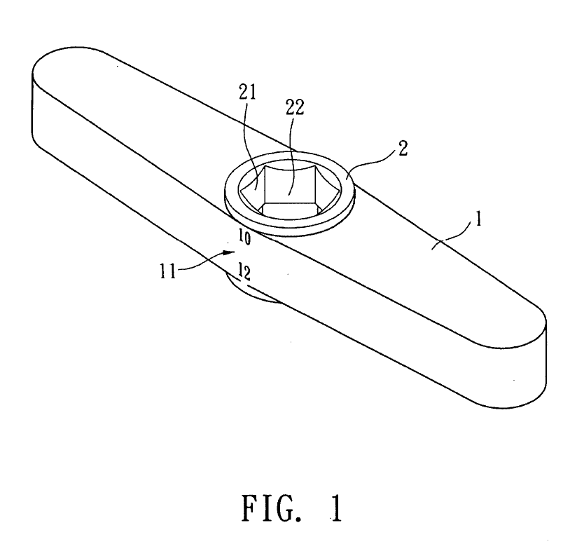

Please refer to FIGS. 1 to 4 for a first embodiment of the invention. The invention, however, is not limited to this particular example.

This embodiment provides a hand tool with an automatic engaging function. It includes a holding part 1 that has at least one driving head 2 at an appropriate position. In this embodiment, the holding part 1 is integrally formed. A single driving head 2 is fixed on its axis. The driving head 2 has at least two sleeve parts 21 disposed coaxially and with different inner diameters. They are stacked inside the driving head 2 to form a sleeve hole 22 for engaging with a working object 2 (the outer hexagon structure of a bolt in this embodiment). The working object 2 automatically embeds into the sleeve hole 22 and matches with the corresponding sleeve part 21.

The holding part 1 has a displaying part 11 that marks the sizes of the sleeves 211, 212 on the outer edge near the driving head 2.

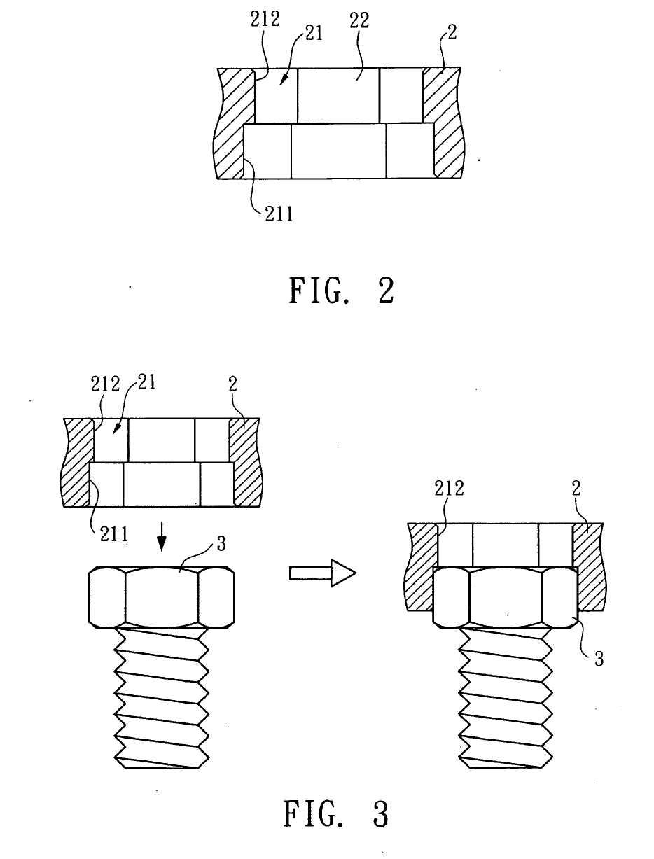

Please refer to FIG. 2. In this embodiment, the driving head 2 has a larger sleeve pail 211 and a smaller sleeve join 212. They are of different sizes and have a hexagonal structure.

Using the above-mentioned structure, the user simply makes a rough visual estimate of the size of a working object 3, and then engages the driving head 2 of appropriate size on it to work. For example, as shown in FIG. 3, the outer diameter of the working object 3 is visually estimated to be about the inner diameter of the larger sleeve part 211 of the driving head 2. In this case, one first engages the larger sleeve part 211 with the working object 3 through the sleeve hole 22 of the driving head 2. The working object 3 is then driven by the larger sleeve part 211.

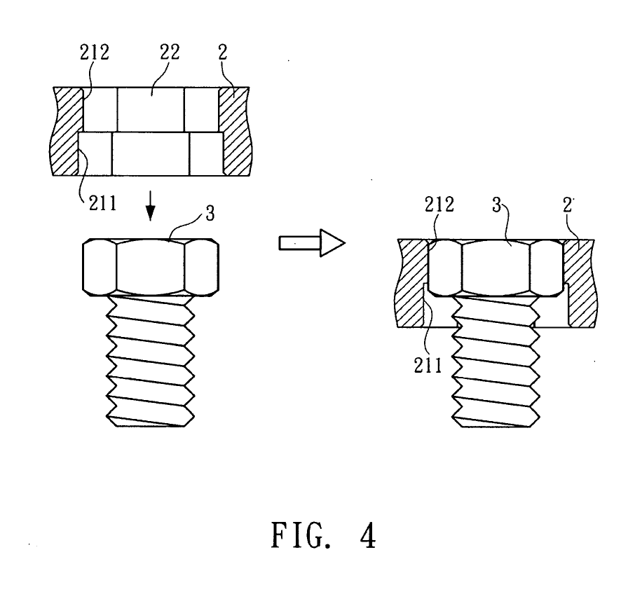

As shown in FIG. 4, if the outer diameter of the working object 3 is about the same as that of the smaller sleeve part 212 of the driving head 2, then the working object 3 goes through the larger sleeve part 211 and stops at the smaller sleeve part 212 when the user engage the larger sleeve part 211 with the working object 3. In this case, the working object 3 is driven by the smaller sleeve part 212.

The invention allows the user to engage the working object 3 in the same direction and the working object 3 automatically engages the sleeve part 21 of the right size. Therefore, the size of working object 3 that can be engaged by the driving head 2 is wider than conventional hand tools. Even if the specification visually measured by the user is slightly different from the actual one or the outer diameter of the working object 3 is damaged after long time use, the invention cans till directly engage with it. With the displaying part 11 on the holding part 1, the diameter of the sleeve part 21 corresponding to the engaged working object 3 is displayed. The user thus knows the outer diameter of the working object 3 for future replacement works. This increases the working efficiency of the user.

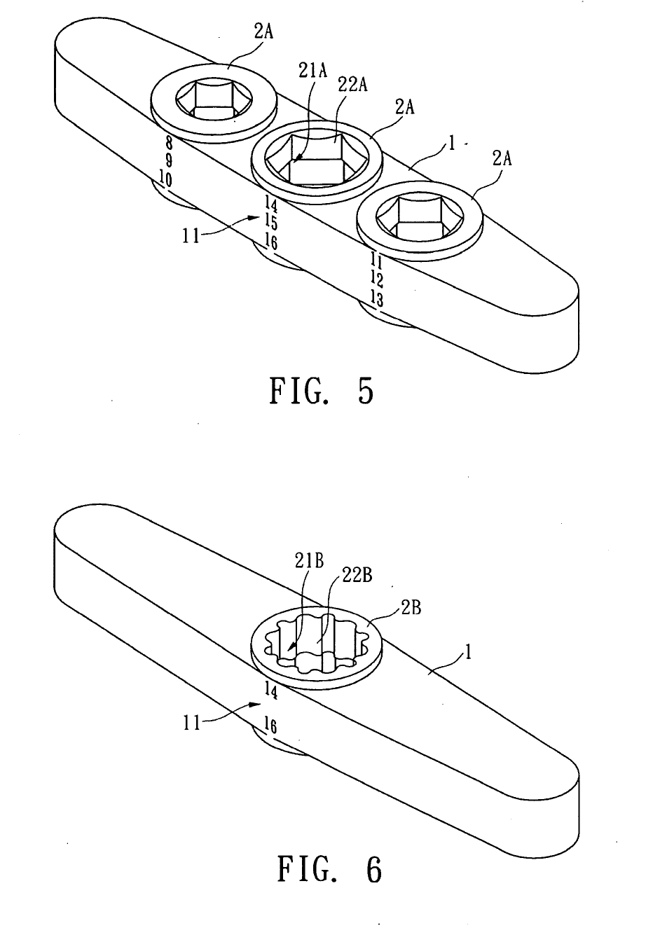

The invention of course has many other embodiments that only vary in minor details. Please refer to FIG. 5 for a second embodiment. In this embodiment, the holding part 1 has three separate driving heads 2A, each of which has three sleeve parts 21A of different sizes. Each of the driving heads 2A forms a sleeve hole 22A for engaging the working object 3. Moreover, each of the sleeve part 21A has a hexagonal structure.

FIG. 6 shows a third embodiment of the invention. The holding part 1 has a driving head 2B on its axis. The driving head 2B has two sleeve parts 21B of different sizes, each of which has an arc structure of a distinct curvature. Therefore, not only can the sleeve hole 22B of the driving head 2B engage with working objects 3 of different sizes using the sleeve parts 21B, the arc structures of different curvatures provide more choices in sizes.

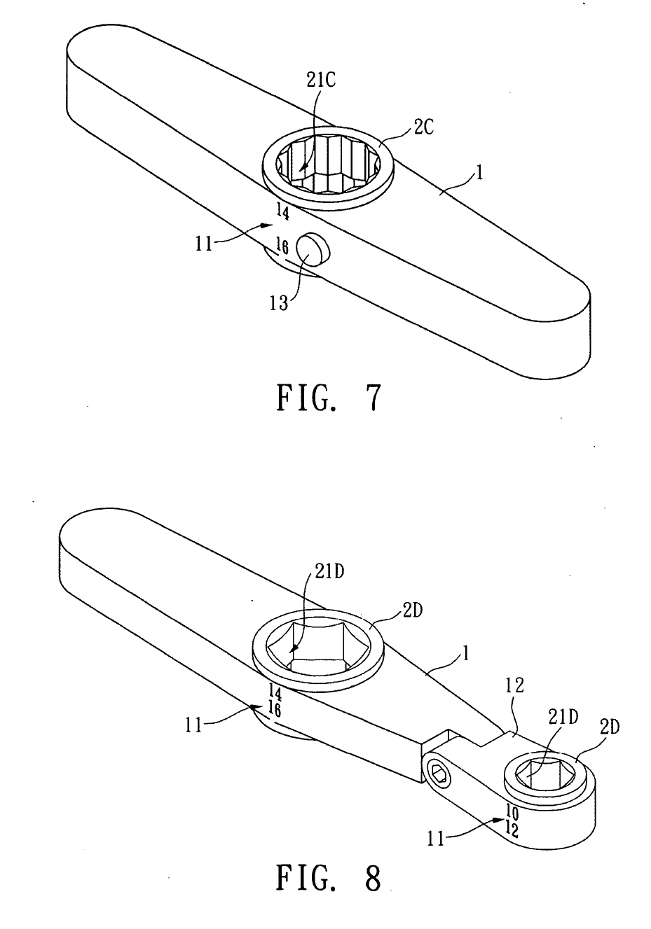

Please refer to FIG. 7 for a fourth embodiment of the invention. The driving head 2C is pivotally disposed on the holding part 1. A ratchet mechanism 13 is interposed between the driving head 2C and the holding part 1. This belongs to the prior art and is not further described herein. The driving head 2C also has two sleeve parts 21C of different sizes. Each of the sleeve parts 21C has a polygonal structure.

Moreover, the holding part 1 and the driving head 2 can have different linking relations. FIG. 8 shows a fifth embodiment of the invention. The holding part 1 is pivotally disposed with a swing object 12 whose orientation can be adjusted. The holding part 1 and the swing object 12 have a driving head 2D, respectively. Each of the driving heads 2D has two sleeve parts 21D of different sizes, and each of which has a hexagonal structure. With the swing object 12, the user has more freedom in uses, without space and orientation limits.

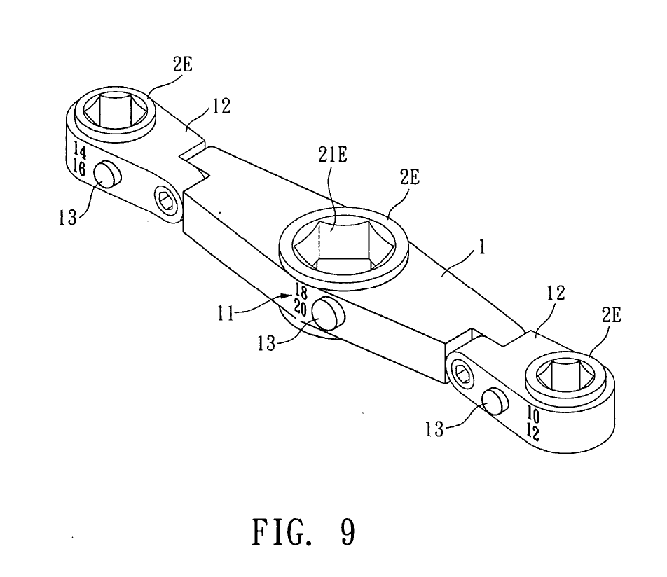

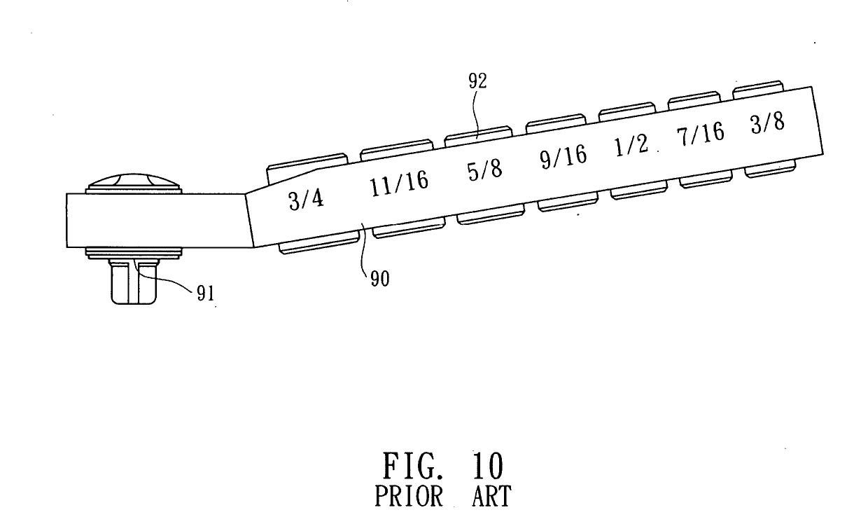

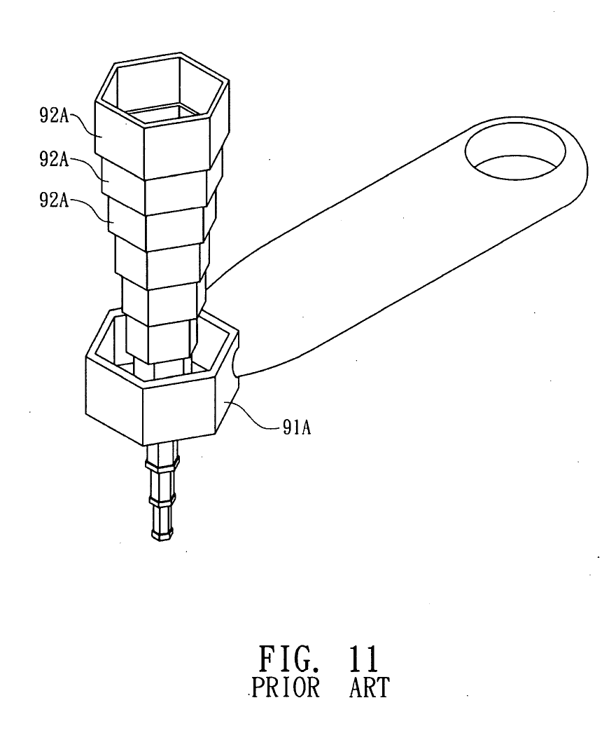

FIG. 9 gives a sixth embodiment of the invention. In this embodiment, both ends of the holding part 1 are pivotally disposed with a swing object 12, respectively. A driving head 2E is pivotally disposed on the holding part 1 and the swing objects 12. A ratchet mechanism 13 is interposed between the holding part 1 and each of the swing objects 12 for each of the driving heads. This part belongs to the prior art and is not further described herein. Each of the driving heads 2E has two sleeve parts 21E of different sizes. Using this configuration, the invention also has no limits in space and orientation.

Although the invention has been described with reference to specific embodiments, this description is not meant to be construed in a limiting sense. Various modifications of the disclosed embodiments, as well as alternative embodiments, will be apparent to people skilled in the art. Therefore, it is contemplated that the appended claims will cover all modifications that fall within the true scope of the invention.

What is claimed is:

1. A hand tool with automatic engaging, comprising:
a holding part that has at least one driving head at an appropriate position;
wherein the driving head has at least two coaxial sleeve parts that have different inner diameters and stack in the diving head, so that the driving head forms a sleeve hole for engaging a working object and the working object is automatically embedded in the sleeve hole and engaged with a sleeve part of the corresponding size.

2. The hand tool with automatic engaging of claim 1, wherein the holding part is integrally formed.

3. The hand tool with automatic engaging of claim 1, wherein the holding part has a displaying part near the outer edge of the driving head for displaying the size of the sleeve part.

4. The hand tool with automatic engaging of claim 1, wherein the driving head is fixed on the holding part.

5. The hand tool with automatic engaging of claim 4, wherein the driving head is fixed on the axis of the holding part.

6. The hand tool with automatic engaging of claim 1, wherein the driving head is pivotally disposed on the holding part.

7. The hand tool with automatic engaging of claim 6, wherein the driving is pivotally disposed on the axis of the holding part.

8. The hand tool with automatic engaging of claim 1, wherein the driving head has a larger sleeve pail and a smaller sleeve part.

9. The hand tool with automatic engaging of claim 1, wherein the driving head has three sleeve parts of different sizes.

10. The hand tool with automatic engaging of claim 1, wherein the holding part has three separate driving heads.

11. The hand tool with automatic engaging of claim 10, wherein each of the driving heads has sleeve parts of three different sizes.

12. The hand tool with automatic engaging of claim 1, wherein each of the sleeve parts is formed by arc structures of different curvatures.

13. The hand tool with automatic engaging of claim 6, wherein a ratchet mechanism is interposed between the driving head and the holding part.

14. The hand tool with automatic engaging of claim 1, wherein the holding part is pivotally disposed with a swing object whose orientation is adjustable, and a driving head is disposed on the holding part and the swing object, respectively.

15. The hand tool with automatic engaging of claim 14, wherein each of the driving heads is fixed on the holding part and the swing object.

16. The hand tool with automatic engaging of claim 14, wherein each of the driving heads is pivotally disposed on the holding part and the swing object, and a ratchet mechanism is interposed between the holding part and the swing object.

17. The hand tool with automatic engaging of claim 14, wherein each of the driving heads has sleeve parts of three different sizes.

18. The hand tool with automatic engaging of claim 1, wherein both ends of the holding part are pivotally disposed with a swing object whose orientation is adjustable, and a driving head is disposed on the holding part and the swing objects, respectively.

19. The hand tool with automatic engaging of claim 18, wherein each of the driving heads is fixed on the holding part and the swing objects.

20. The hand tool with automatic engaging of claim 18, wherein each of the driving heads is pivotally disposed on the holding part and the swing objects, and a ratchet mechanism is interposed between the holding part and each of the swing objects, respectively.

21. The hand tool with automatic engaging of claim 18, wherein each of the driving heads has sleeve parts of three different sizes.

22. The hand tool with automatic engaging of claim 1, wherein each of the sleeve parts has a hexagonal structure inside.

23. The hand tool with automatic engaging of claim 1, wherein each of the sleeve parts has a polygonal structure inside.
